(19) United States
(12) Patent Application Publication
(10) Pub. No.: US 2021/0068027 A1
(43) Pub. Date: Mar. 4, 2021

(54) METHOD FOR DETERMINING MOBILITY STATE OF UE AND DEVICE SUPPORTING THE SAME

(71) Applicant: LG ELECTRONICS INC., Seoul (KR)

(72) Inventors: Oanyong LEE, Seoul (KR); Youngdae LEE, Seoul (KR)

(73) Assignee: LG ELECTRONICS INC., Seoul (KR)

(21) Appl. No.: 16/644,036

(22) PCT Filed: Sep. 28, 2018
(86) PCT No.: PCT/KR2018/011533

§ 371 Date: Mar. 3, 2020

Related U.S. Application Data
(60) Provisional application No. 62/564,289, filed on Sep. 28, 2017.

(51) Int. Cl. H04W 36/32; H04W 36/00; H04B 17/318

(52) U.S. Cl. CPC H04W 36/32; H04B 17/318; H04W 36/0058; H04W 36/0085

(57) ABSTRACT

Provided are a method of determining mobility state of an UE and a device supporting the method. According to one embodiment of the present disclosure, the method includes: measuring a first reference signal received power (RSRP) of a serving cell at a first time point; measuring a second RSRP of the serving cell at a second time point within a first duration starting from the first time point; comparing the first RSRP and the second RSRP; and estimating for a mobility state of the UE based on a difference between the first RSRP and the second RSRP.

### TECHNICAL FIELD

The present invention relates to a wireless communication system, and more particularly, to a method for determining mobility state of UE and a device supporting the same.

### BACKGROUND

Efforts have been made to develop an improved 5^{th}-generation (5G) communication system or a pre-5G communication system in order to satisfy a growing demand on radio data traffic after commercialization of a 4^{th}-generation (4G) communication system. A standardization act for a 5G mobile communication standard work has been formally started in 3GPP, and there is ongoing discussion in a standardization working group under a tentative name of a new radio access (NR).

Meanwhile, an upper layer protocol defines a protocol state to consistently manage an operational state of a user equipment (UE), and indicates a function and procedure of the UE in detail. In the discussion on the NR standardization, an RRC state is discussed such that an RRC_CONNECTED state and an RRC_IDLE state are basically defined, and an RRC_INACTIVE state is additionally introduced.

Meanwhile, In the LTE network, mobility state of a UE in idle mode is determined by number of cell reselections during recent time period. That is, the UE may determine its mobility state only based on the number of cell reselection. As the UE performs mobility state estimation frequently in a certain time period, the UE determines itself as being in higher mobility state. So the UE cannot realize its own mobility as far as cell reselection is not occurred even though it is moving fast.

### SUMMARY

According to a prior art, the UE cannot realize its own mobility as far as cell reselection is not occurred even though it is moving fast.

According to an embodiment of the present invention, a method for a user equipment (UE) in wireless communication system is provided. The method may comprise: measuring a first reference signal received power (RSRP) of a serving cell at a first time point; measuring a second RSRP of the serving cell at a second time point within a first duration starting from the first time point; comparing the first RSRP and the second RSRP; and estimating for a mobility state of the UE based on a difference between the first RSRP and the second RSRP.

The mobility state may be estimated based on the difference between the first RSRP and the second RSRP, and at least one of level thresholds related to the mobility state.

The second RSRP of the serving cell may be measured at the second time point after a second duration starting from the first time point.

The method may further comprise: determining the mobility state of the UE based on multiple results of estimation for the mobility state.

The mobility state of the UE may be determined as a certain mobility state, if the mobility state of the UE is estimated as the certain mobility state for a preconfigured number of times in a row.

The mobility state of the UE may be determined as a highest mobility state among the multiple results of the estimation of the mobility state.

The method may further comprise: preparing for cell reselection procedure, when the mobility state of the UE is determined as high mobility state.

According to another embodiment of the present invention, a user equipment (UE) in a wireless communication system is provided. The UE may comprise: a transceiver for transmitting or receiving a radio signal; and a processor coupled to the transceiver, the processor configured to: measure a first reference signal received power (RSRP) of a serving cell at a first time point; measure a second RSRP of the serving cell at a second time point within a first duration starting from the first time point; compare the first RSRP and the second RSRP; and estimate for a mobility state of the UE based on a difference between the first RSRP and the second RSRP.

The mobility state may be estimated based on the difference between the first RSRP and the second RSRP, and at least one of level thresholds related to the mobility state.

The second RSRP of the serving cell may be measured at the second time point after a second duration starting from the first time point.

The processor may be further configured to: determine the mobility state of the UE based on multiple results of estimation for the mobility state.

The mobility state of the UE may be determined as a certain mobility state, if the mobility state of the UE is estimated as the certain mobility state for a preconfigured number of times in a row.

The mobility state of the UE may be determined as a highest mobility state among the multiple results of the estimation of the mobility state.

The processor may be further configured to: prepare for cell reselection procedure, when the mobility state of the UE is determined as high mobility state.

When the mobility state is estimated according to an embodiment of the present invention, the UE may vary the parameters related to the cell reselection. When the UE enters high mobility state, the UE should prepare for the quick cell change. If following the rules in legacy LTE network, the UE may scale the cell reselection-related parameters (i.e. Q_{hyst} and T_{reselectionXRAT}) or relax the measurement rules for cell reselection so that the UE starts to perform the neighbor cell measurement earlier. When the UE enters low mobility state (being stationary), it may mean the measured serving cell power varies very slowly. So it may be considered that the UE is in stationary state. If then, the UE may not perform neighbor cell measurement to reduce power consumption.

### BRIEF DESCRIPTION OF THE DRAWINGS

FIG. 1 shows an example of a wireless communication system to which technical features of the present invention can be applied.

FIG. 2 shows another example of a wireless communication system to which technical features of the present invention can be applied.

FIG. 3 shows a block diagram of a user plane protocol stack to which technical features of the present invention can be applied.

FIG. 4 shows a block diagram of a control plane protocol stack to which technical features of the present invention can be applied.

FIG. 5 shows an example for demonstrating problems in legacy method.

FIG. 6 shows an example of Srxlevprev and Srxlevnewest evaluation using validity timer according to an embodiment of the present invention.

FIG. 7 shows an example of Srxlevprev and Srxlevnewest evaluation using wait timer according to an embodiment of the present invention.

FIG. 8 shows a schematic comparison graph of parameters in each mobility state according to an embodiment of the present invention.

FIG. 9 shows an example of a UE passing by a serving cell in high speed according to an embodiment of the present invention.

FIG. 10 shows Srxlev variation of the UE passing by a serving cell according to an embodiment of the present invention.

FIG. 11 shows an example of a method for determining mobility state of a UE according to an embodiment of the present invention.

FIG. 12 shows a structure of UE according to an embodiment of the present invention.

FIG. 13 shows an example of a method for determining mobility state of a UE according to an embodiment of the present invention.

FIG. 14 shows a structure of network according to an embodiment of the present invention.

### DETAILED DESCRIPTION

The technical features described below may be used by a communication standard by the 3rd generation partnership project (3GPP) standardization organization, a communication standard by the institute of electrical and electronics engineers (IEEE), etc. For example, the communication standards by the 3GPP standardization organization include long-term evolution (LTE) and/or evolution of LTE systems. The evolution of LTE systems includes LTE-advanced (LTE-A), LTE-A Pro, and/or 5G new radio (NR). The communication standard by the IEEE standardization organization includes a wireless local area network (WLAN) system such as IEEE 802.11a/b/g/n/ac/ax. The above system uses various multiple access technologies such as orthogonal frequency division multiple access (OFDMA) and/or single carrier frequency division multiple access (SC-FDMA) for downlink (DL) and/or uplink (DL). For example, only OFDMA may be used for DL and only SC-FDMA may be used for UL. Alternatively, OFDMA and SC-FDMA may be used for DL and/or UL.

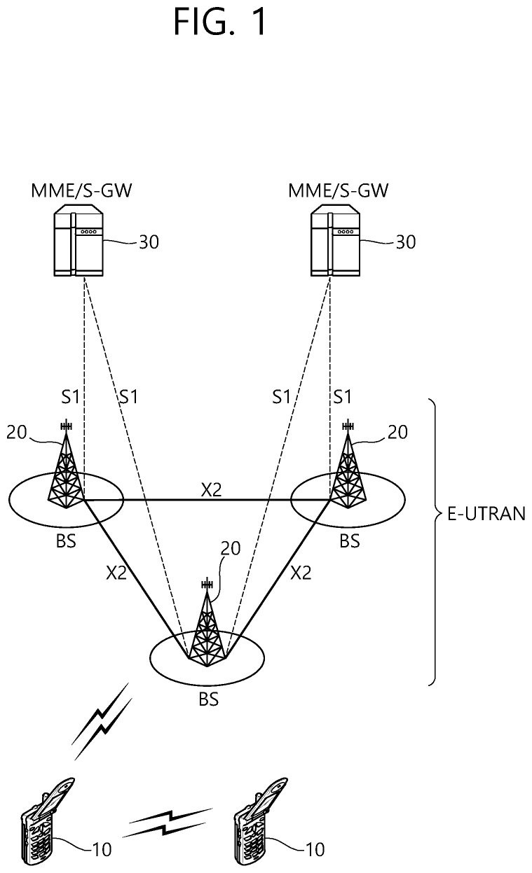

FIG. 1 shows an example of a wireless communication system to which technical features of the present invention can be applied. Specifically, FIG. 1 shows a system architecture based on an evolved-UMTS terrestrial radio access network (E-UTRAN). The aforementioned LTE is a part of an evolved-UTMS (e-UMTS) using the E-UTRAN.

Referring to FIG. 1, the wireless communication system includes one or more user equipment (UE; 10), an E-UTRAN and an evolved packet core (EPC). The UE 10 refers to a communication equipment carried by a user. The UE 10 may be fixed or mobile. The UE 10 may be referred to as another terminology, such as a mobile station (MS), a user terminal (UT), a subscriber station (SS), a wireless device, etc.

The E-UTRAN consists of one or more base station (BS) 20. The BS 20 provides the E-UTRA user plane and control plane protocol terminations towards the UE 10. The BS 20 is generally a fixed station that communicates with the UE 10. The BS 20 hosts the functions, such as inter-cell radio resource management (MME), radio bearer (RB) control, connection mobility control, radio admission control, measurement configuration/provision, dynamic resource allocation (scheduler), etc. The BS may be referred to as another terminology, such as an evolved NodeB (eNB), a base transceiver system (BTS), an access point (AP), etc.

A downlink (DL) denotes communication from the BS 20 to the UE 10. An uplink (UL) denotes communication from the UE 10 to the BS 20. A sidelink (SL) denotes communication between the UEs 10. In the DL, a transmitter may be a part of the BS 20, and a receiver may be a part of the UE 10. In the UL, the transmitter may be a part of the UE 10, and the receiver may be a part of the BS 20. In the SL, the transmitter and receiver may be a part of the UE 10.

The EPC includes a mobility management entity (MME), a serving gateway (S-GW) and a packet data network (PDN) gateway (P-GW). The MME hosts the functions, such as non-access stratum (NAS) security, idle state mobility handling, evolved packet system (EPS) bearer control, etc. The S-GW hosts the functions, such as mobility anchoring, etc. The S-GW is a gateway having an E-UTRAN as an endpoint. For convenience, MME/S-GW 30 will be referred to herein simply as a “gateway,” but it is understood that this entity includes both the MME and S-GW. The P-GW hosts the functions, such as UE Internet protocol (IP) address allocation, packet filtering, etc. The P-GW is a gateway having a PDN as an endpoint. The P-GW is connected to an external network.

The UE 10 is connected to the BS 20 by means of the Uu interface. The UEs 10 are interconnected with each other by means of the PC5 interface. The BSs 20 are interconnected with each other by means of the X2 interface. The BSs 20 are also connected by means of the S1 interface to the EPC, more specifically to the MME by means of the S1-MME interface and to the S-GW by means of the S1-U interface. The S1 interface supports a many-to-many relation between MMEs/S-GWs and BSs.

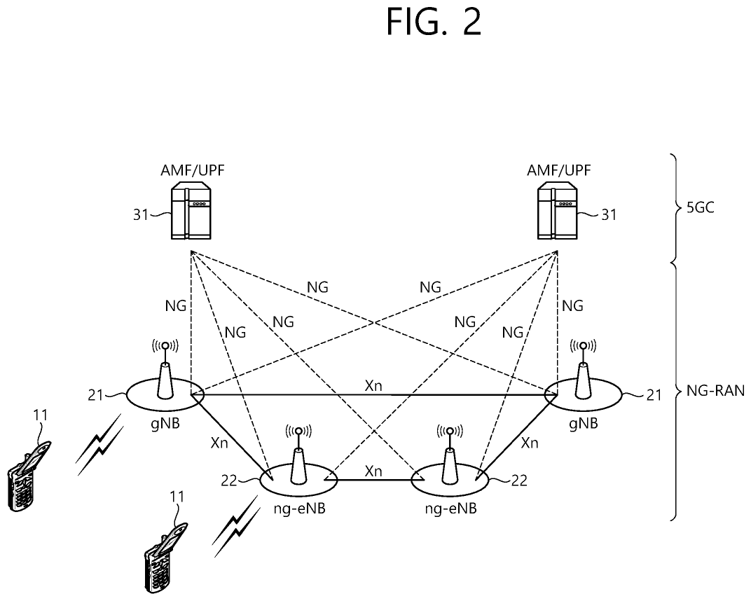

FIG. 2 shows another example of a wireless communication system to which technical features of the present invention can be applied. Specifically, FIG. 2 shows a system architecture based on a 5G new radio access technology (NR) system. The entity used in the 5G NR system (hereinafter, simply referred to as “NW”) may absorb some or all of the functions of the entities introduced in FIG. 1 (e.g. eNB, MME, S-GW). The entity used in the NR system may be identified by the name “NG” for distinction from the LTE/LTE-A.

Referring to FIG. 2, the wireless communication system includes one or more UE 11, a next-generation RAN (NG-RAN) and a 5th generation core network (5GC). The NG-RAN consists of at least one NG-RAN node. The NG-RAN node is an entity corresponding to the BS 10 shown in FIG. 1. The NG-RAN node consists of at least one gNB 21 and/or at least one ng-eNB 22. The gNB 21 provides NR user plane and control plane protocol terminations towards the UE 11. The ng-eNB 22 provides E-UTRA user plane and control plane protocol terminations towards the UE 11.

The 5GC includes an access and mobility management function (AMF), a user plane function (UPF) and a session management function (SMF). The AMF hosts the functions, such as NAS security, idle state mobility handling, etc. The AMF is an entity including the functions of the conventional MME. The UPF hosts the functions, such as mobility anchoring, protocol data unit (PDU) handling. The UPF an entity including the functions of the conventional S-GW. The SMF hosts the functions, such as UE IP address allocation, PDU session control.

The gNBs and ng-eNBs are interconnected with each other by means of the Xn interface. The gNBs and ng-eNBs are also connected by means of the NG interfaces to the 5GC, more specifically to the AMF by means of the NG-C interface and to the UPF by means of the NG-U interface.

A protocol structure between network entities described above is described. On the system of FIG. 1 and/or FIG. 2, layers of a radio interface protocol between the UE and the network (e.g. NG-RAN and/or E-UTRAN) may be classified into a first layer (L1), a second layer (L2), and a third layer (L3) based on the lower three layers of the open system interconnection (OSI) model that is well-known in the communication system.

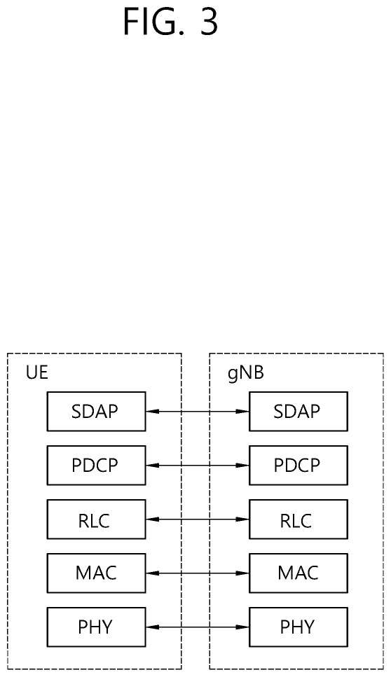

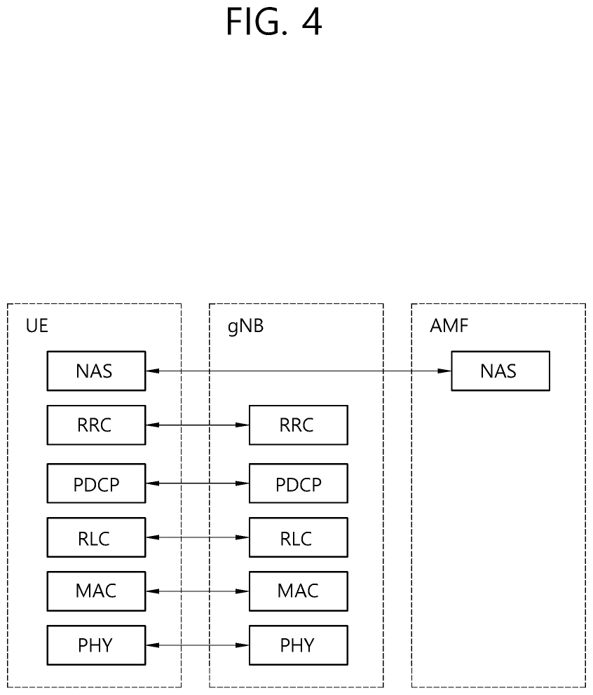

FIG. 3 shows a block diagram of a user plane protocol stack to which technical features of the present invention can be applied. FIG. 4 shows a block diagram of a control plane protocol stack to which technical features of the present invention can be applied. The user/control plane protocol stacks shown in FIG. 3 and FIG. 4 are used in NR. However, user/control plane protocol stacks shown in FIG. 3 and FIG .4 may be used in LTE/LTE-A without loss of generality, by replacing gNB/AMF with eNB/MME.

Referring to FIG. 3 and FIG. 4, a physical (PHY) layer belonging to L1. The PHY layer offers information transfer services to media access control (MAC) sublayer and higher layers. The PHY layer offers to the MAC sublayer transport channels. Data between the MAC sublayer and the PHY layer is transferred via the transport channels. Between different PHY layers, i.e., between a PHY layer of a transmission side and a PHY layer of a reception side, data is transferred via the physical channels.

The MAC sublayer belongs to L2. The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

The service data adaptation protocol (SDAP) sublayer belong to L2. The SDAP sublayer is only defined in the user plane. The SDAP sublayer is only defined for NR. The main services and functions of SDAP include, mapping between a QoS flow and a data radio bearer (DRB), and marking QoS flow ID (QFI) in both DL and UL packets. The SDAP sublayer offers to 5GC QoS flows.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions, QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the base station.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

The physical channels may be modulated according to OFDM processing and utilizes time and frequency as radio resources. The physical channels consist of a plurality of orthogonal frequency division multiplexing (OFDM) symbols in time domain and a plurality of subcarriers in frequency domain. One subframe consists of a plurality of OFDM symbols in the time domain. A resource block is a resource allocation unit, and consists of a plurality of OFDM symbols and a plurality of subcarriers. In addition, each subframe may use specific subcarriers of specific OFDM symbols (e.g. first OFDM symbol) of the corresponding subframe for a physical downlink control channel (PDCCH), i.e. L1/L2 control channel. A transmission time interval (TTI) is a basic unit of time used by a scheduler for resource allocation. The TTI may be defined in units of one or a plurality of slots, or may be defined in units of mini-slots.

The transport channels are classified according to how and with what characteristics data are transferred over the radio interface. DL transport channels include a broadcast channel (BCH) used for transmitting system information, a downlink shared channel (DL-SCH) used for transmitting user traffic or control signals, and a paging channel (PCH) used for paging a UE. UL transport channels include an uplink shared channel (UL-SCH) for transmitting user traffic or control signals and a random access channel (RACH) normally used for initial access to a cell.

Different kinds of data transfer services are offered by MAC sublayer. Each logical channel type is defined by what type of information is transferred. Logical channels are classified into two groups: control channels and traffic channels.

Control channels are used for the transfer of control plane information only. The control channels include a broadcast control channel (BCCH), a paging control channel (PCCH), a common control channel (CCCH) and a dedicated control channel (DCCH). The BCCH is a DL channel for broadcasting system control information. The PCCH is DL channel that transfers paging information, system information change notifications. The CCCH is a channel for transmitting control information between UEs and network. This channel is used for UEs having no RRC connection with the network. The DCCH is a point-to-point bi-directional channel that transmits dedicated control information between a UE and the network. This channel is used by UEs having an RRC connection.

Traffic channels are used for the transfer of user plane information only. The traffic channels include a dedicated traffic channel (DTCH). The DTCH is a point-to-point channel, dedicated to one UE, for the transfer of user information. The DTCH can exist in both UL and DL.

Regarding mapping between the logical channels and transport channels, in DL, BCCH can be mapped to BCH, BCCH can be mapped to DL-SCH, PCCH can be mapped to PCH, CCCH can be mapped to DL-SCH, DCCH can be mapped to DL-SCH, and DTCH can be mapped to DL-SCH. In UL, CCCH can be mapped to UL-SCH, DCCH can be mapped to UL-SCH, and DTCH can be mapped to UL-SCH.

Hereinafter, estimating mobility states of a UE is described.

Besides Normal-mobility state a High-mobility and a Medium-mobility state are applicable if the parameters (T_{CRmax}, N_{CR_H}, N_{CR_M} and T_{CRmaxHyst}) are sent in the system information broadcast of the serving cell.

State detection criteria is classified into Medium-mobility state criteria and High-mobility state criteria.

Medium-mobility state criteria:
If number of cell reselections during time period T_{CRmax} exceeds N_{CR_M} and not exceeds N_{CR_H}

High-mobility state criteria:
If number of cell reselections during time period TCRmax exceeds NCR_H

The UE shall not count consecutive reselections between same two cells into mobility state detection criteria if same cell is reselected just after one other reselection.

State transitions are described as follow.

The UE shall:
if the criteria for High-mobility state is detected, enter High-mobility state.
else if the criteria for Medium-mobility state is detected, enter Medium-mobility state.
else if criteria for either Medium- or High-mobility state is not detected during time period T_{CRmaxHyst}, enter Normal-mobility state.

If the UE is in High- or Medium-mobility state, the UE shall apply the speed dependent scaling rules.

Hereinafter, NB-IoT is described.

NB-IoT provides access to network services using physical layer optimized for very low power consumption (e.g. full carrier bandwidth is 180 kHz, subcarrier spacing can be 3.75 kHz or 15 kHz).

As indicated in the relevant subclauses in this specification, a number of E-UTRA protocol functions supported by all Rel-8 UEs are not used for NB-IoT and need not be supported by eNBs and UEs only using NB-IoT.

In this version of the specification, a number of functions including inter-RAT mobility, handover, measurement reports, public warning functions, GBR, CSG, support of HeNBs, relaying, carrier aggregation, dual connectivity, NAICS, MBMS, real-time services, interference avoidance for in-device coexistence, RAN assisted MILAN interworking, sidelink communication/discovery, MDT, emergency call, CS fallback, self-configuration/self-optimisation, ACB, EAB, ACDC and SSAC are not supported for NB-IoT.

In the LTE network, mobility state of a UE in idle mode is determined by number of cell reselections during recent time period. According to the mobility state estimation, the UE may determine itself as being in Normal/Medium/High-mobility state and may vary cell reselection-related parameters (e.g. Qhyst, TreselectionXRAT) based on the mobility state so that the UE may be able to perform cell reselection more frequently in higher mobility state. However, current mobility state estimation scheme has several faults as described below:

1. Number of cell reselection is the only parameter for the evaluation. That is, the UE may determine its mobility state only based on the number of cell reselection. As the UE performs mobility state estimation frequently in a certain time period, the UE determines itself as being in higher mobility state. So the UE cannot realize its own mobility as far as cell reselection is not occurred even though it is moving fast.

2. The number of cell reselection-based method does not work in low mobility state. Whether moving slowly or being in normal speed, the UE cannot realize its low mobility state as far as cell reselection is not performed.

3. It is not adequate for NB-IoT or MTC environment. When a UE is temporarily/permanently stationary, the UE cannot realize it. As far as no cell reselection is performed, UE cannot distinguish no mobility state and low mobility state. If there is only one cell nearby, there is same problem. As only then the cell reselection will be performed when the UE reaches the cell boundary, so the UE cannot detect any mobility until then.

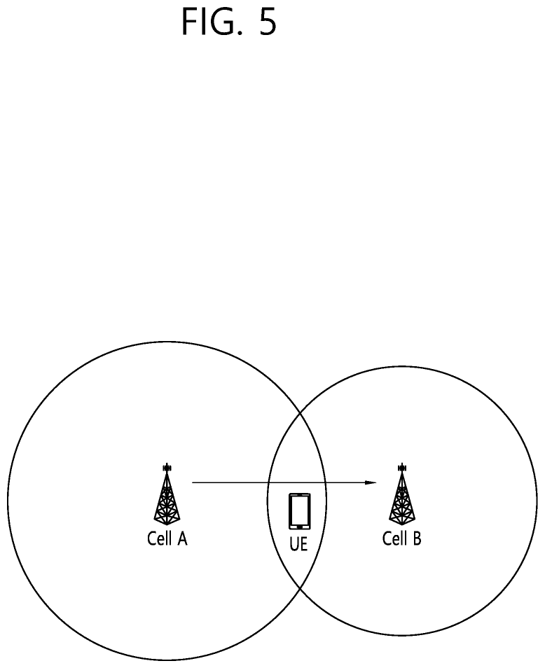

FIG. 5 shows an example for demonstrating problems in legacy method.

Referring to FIG. 5, a UE is moving fast from cell A to B. As the cell A has higher coverage, the UE does not perform cell reselection until the measured RSRP of cell B strong enough, so that the UE is still in medium mobility state. Therefore, after cell B has become cell reselection candidate cell, the UE has to wait long Treselection time to reselect cell B even though the UE is heading to cell B fast.

To solve problems described above, a method for performing UE mobility state estimation according to an embodiment of the present invention is provided.

According to an embodiment of the present invention, variation of measured serving cell RSRP may be used to estimate UE's mobility state, instead of number of cell reselection. Basic concept is to compare the newly measured Srxlev and right previous Srxlev value of the serving cell. The larger difference means that the UE is moving faster, i.e. higher mobility. The smaller difference means that the UE is moving slower, i.e. lower mobility.

Mobility state criteria is described as below:

1. Low-Mobility state criteria:

Srxlevₚᵣₑᵥ−Q_{low}21 Srxlev_{newest}<Srxlevₚᵣₑᵥ+Q_{low}

2. Medium-Mobility state criteria:

Srxlevₚᵣₑᵥ+Q_{low}<Srxlev_{newest}<Srxlevₚᵣₑᵥ+Q_{medium} or;

Srxlevₚᵣₑᵥ−Q_{medium}<Srxlev_{newest}>Srxlevₚᵣₑᵥ−Q_{low}

3. High-Mobility state criteria:

Srxlevₚᵣₑᵥ+Q_{medium}<Srxlev_{newest}<Srxlevₚᵣₑᵥ+Q_{high} or;

Srxlevₚᵣₑᵥ−Q_{high}<Srxlev_{newest}>Srxlevₚᵣₑᵥ−Q_{medium}

4. N-level higher-Mobility state criteria:

Srxlevₚᵣₑᵥ+Q_{high}+(N−1)×Q_{higherLev}<Srxlev_{newest}<Srxlevₚᵣₑᵥ+Q_{high}+N×Q_{higherLev} or;

Srxlevₚᵣₑᵥ−Q_{high}−N×Q_{higherLev}<Srxlev_{newest}<Srxlevₚᵣₑᵥ−Q_{high}−(N−1)×Q_{higherLev}

In the mobility state criteria, Srxlev_{newest} is Srxlev value evaluated from most recently measured serving cell power. Srxlevₚᵣₑᵥ is Srxlev value evaluated from right previously measured serving cell power. Q_{low}, Q_{medium} and Q_{high} are threshold parameters for each mobility state. Q_{higherLev} is level threshold parameters for each N-level higher-mobility states. N is Level parameters for higher-mobility states. N may be positive integer values. N=0 means high-mobility state.

Hereinafter, definition of Srxlevₚᵣₑᵥ and Srxlev_{newest} is described.

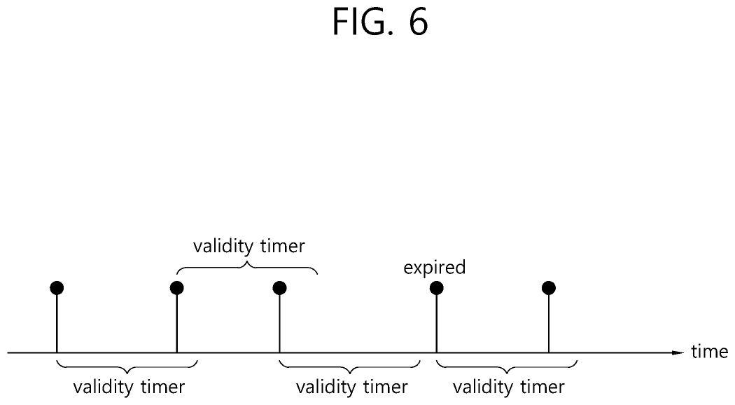

FIG. 6 shows an example of Srxlevₚᵣₑᵥ and Srxlev_{newest} evaluation using validity timer according to an embodiment of the present invention. According to an embodiment of the present invention, right next measurement result may be used.

Referring to FIG. 6, the UE may use right next measured serving cell RSRP e.g. a Srxlev_{newest}, as long as the right next measurement has performed within certain time after evaluating Srxlevₚᵣₑᵥ. The certain time in this embodiment may be referred as a first duration. According to an embodiment, a validity timer may be used to determine whether the first duration is passed or not. If the next measurement has performed later than the first duration, Srxlevprev is expired and the next measurement is used for evaluating new Srxlevₚᵣₑᵥ value and wait for the next measurement of serving cell RSRP in order to evaluate new Srxlev_{newest}.

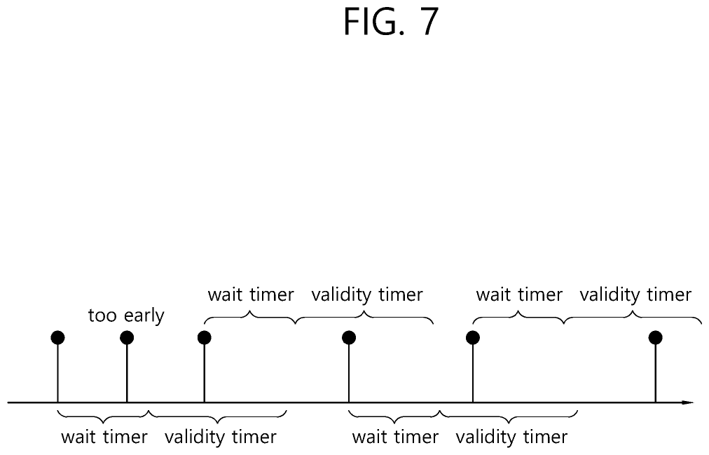

FIG. 7 shows an example of Srxlevₚᵣₑᵥ and Srxlev_{newest} evaluation using wait timer according to an embodiment of the present invention. According to an embodiment of the present invention, the first measured value after certain time has elapsed may be used.

Referring to FIG. 7, the UE may wait for certain time after evaluating Srxlevₚᵣₑᵥ. The certain time in this embodiment may be referred as a second duration. After the second duration expires, the UE may use first measured serving cell RSRP for Srxlev_{newest}, because too early measurement may not reflect the UE's mobility appropriately. According to an embodiment of the present invention, a wait timer may be used to determine whether the second duration is passed or not. It can be also considered to add one more timer to wait for the new measurement, after the second duration expires.

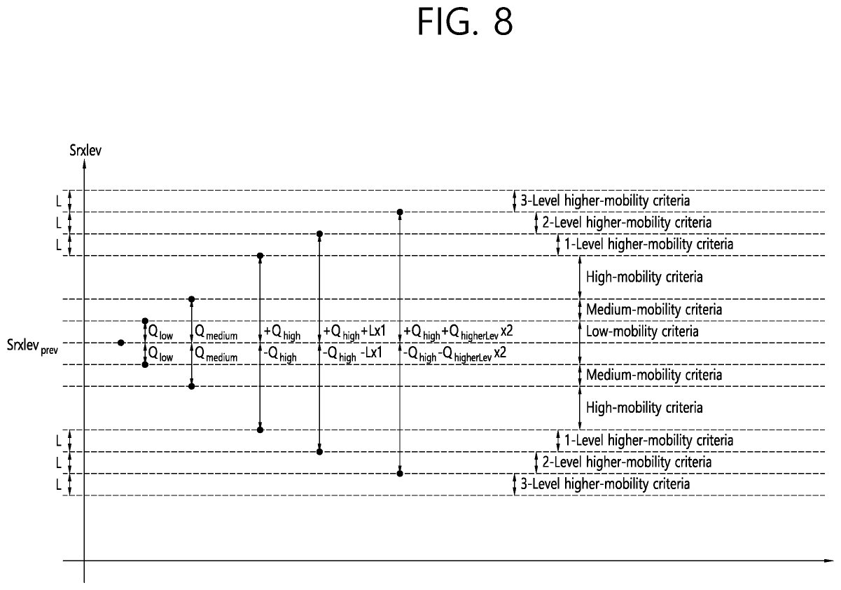

FIG. 8 shows a schematic comparison graph of parameters in each mobility state according to an embodiment of the present invention.

Referring to FIG. 8, UE may determine its mobility state as follow:

1. If the UE satisfies low-mobility state criteria more than Mlow times in last t seconds, the UE may consider that the UE is in Low-mobility state.

2. If the UE satisfies medium-mobility state criteria more than Mmedium times in last t seconds, the UE may consider that the UE is in Medium-mobility state.

3. If the UE satisfies high-mobility state criteria more than Mhigh times in last t seconds, the UE may consider that the UE is in high-mobility state.

4. If the UE satisfies N-level higher-mobility state criteria more than once in last t seconds, the UE may consider that the UE is in N-level higher-mobility state.

5. If the UE satisfies multiple number of mobility states, UE should select higher mobility state. For example, medium-mobility state may be considered as higher than Low-mobility state, and high-mobility state may be considered as higher than Medium-mobility state. Among N-level high-mobility states, mobility state of higher N value may have higher mobility state.

Srxlevprev and Srxlevnewest are consecutively measured serving cell power, so the range of the parameters in each mobility state is not absolute value, but relative to Srxlevprev. Also, mobility speed of a UE varies often enough, so satisfaction of the mobility state of the UE can be different in each measurement periodicity.

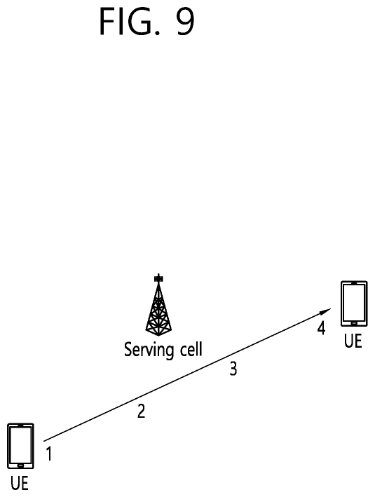

FIG. 9 shows an example of a UE passes by a serving cell in high speed according to an embodiment of the present invention.

Referring to FIG. 9, it is assumed that a UE passing by its serving cell in high speed. The black arrow shows moving route of the UE. At point #1, serving cell power is below average, but the measured power increases when the UE gets closer to the serving cell at point #2. After passing by the serving cell at point #3 and point #4, the UE is still in high speed, the measured power decreases rapidly.

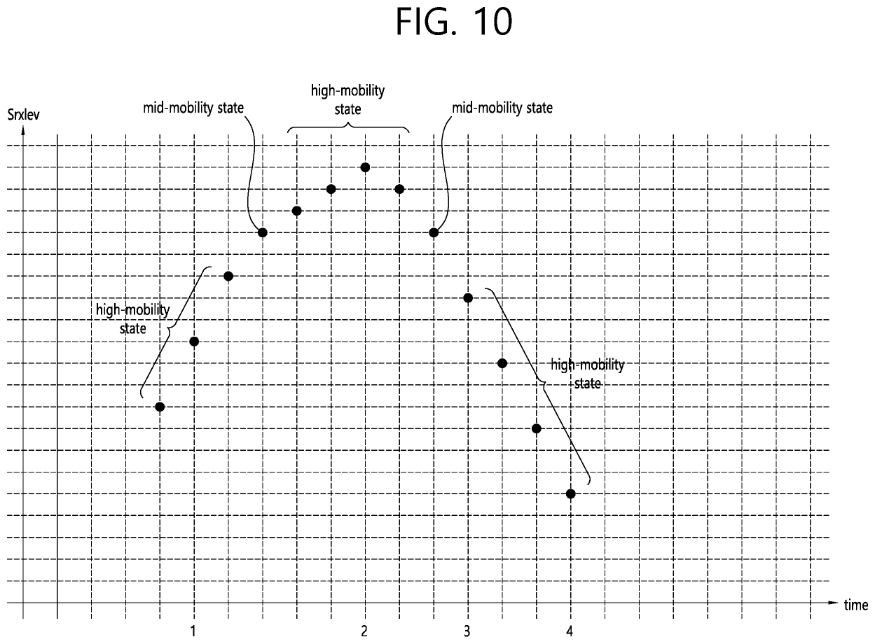

FIG. 10 shows Srxlev variation of the UE passing by a serving cell according to an embodiment of the present invention. Referring FIG.10, if Srxlev increases or decreases of three blocks in the graph means that the UE speed is in mobility state of high. Also, if Srxlev increases or decreases of two blocks in the graph means that the UE speed is in mobility state of medium. Also, if Srxlev increases or decreases of one block in the graph means that the UE speed is in mobility state of low. Each point shown FIG. 10 corresponds to point shown in FIG. 9, respectively.

In point #1, the UE is moving toward the serving cell in high speed, so Srxlev is increasing fast. The UE may be in high-mobility state.

In point #2, the UE is getting closer to the serving cell, so the measured power varies slowly. Srxlev value reaches maximum value at the closest point to the cell, then the Srxlev value may go into decrease. As Srxlev value varies slowly near the serving cell, now the UE may enter low-mobility state.

In point #3, after UE passes by the serving cell and is in high speed, the Srxlev value may go into decrease rapidly. High-mobility state criteria has just satisfied once yet, the UE may be still in low-mobility state. The UE has to satisfy high-mobility state criteria more times to enter the high-mobility state.

In point #4, the UE is still satisfying the high-mobility state criteria consecutively, the UE enters high-mobility state.

The Srxlev value range of low/medium/high mobility state may not overlap to each other. So, if the UE is moving under speed of high mobility state, satisfaction of multiple mobility state criteria may not occur in a measurement periodicity.

However, we expect that satisfaction of each N-level higher mobility state by the UE would not occur frequently compared with mobility states mentioned right above (i.e. low/medium/high mobility states). Regarding the very high speed mobility UE, conditions for entering N-level higher mobility state was mitigated so that satisfying just once is enough to enter the mobility state. Also, as mentioned in FIG.8, N-level higher mobility state of higher N value may have higher priority, than any other mobility states. If a UE satisfies N-level higher mobility criteria once, the UE may keep the higher mobility state for the period of time t unless the UE satisfies higher mobility state criteria. This system would more effective in very high speed UE, such as being in high speed train.

When the mobility state is estimated according to an embodiment of the present invention, the UE may vary the parameters related to the cell reselection. When the UE enters high mobility state, the UE should prepare for the quick cell change. If following the rules in legacy LTE network, the UE may scale the cell reselection-related parameters (i.e. Q_{hyst} and T_{reselectionXRAT}) or relax the measurement rules for cell reselection so that the UE starts to perform the neighbor cell measurement earlier. When the UE enters low mobility state (being stationary), it may mean the measured serving cell power varies very slowly. So it may be considered that the UE is in stationary state. If then, the UE may not perform neighbor cell measurement to reduce power consumption.

According to embodiments of the present invention, the UE may measure its mobility state precisely, by determining the UE speed based on serving cell quality.

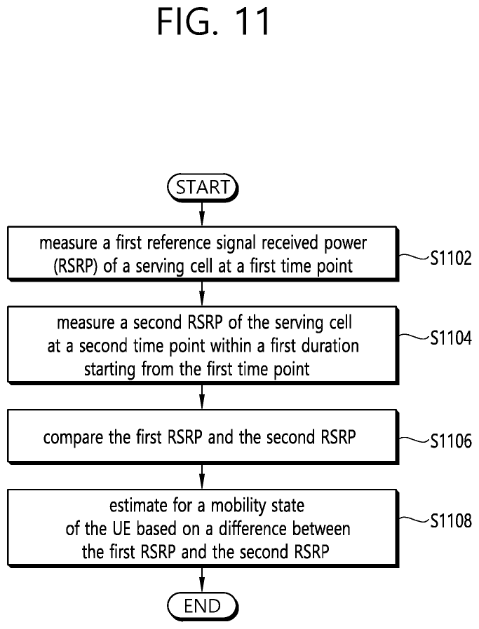

FIG. 11 shows an example of a method for determining mobility state of a UE according to an embodiment of the present invention.

In step S1102, the UE may measure a first reference signal received power (RSRP) of a serving cell at a first time point.

In step S1104, the UE may measure a second RSRP of the serving cell at a second time point within a first duration starting from the first time point. The mobility state may be estimated based on the difference between the first RSRP and the second RSRP, and at least one of level thresholds related to the mobility state. The second RSRP of the serving cell may be measured at the second time point after a second duration starting from the first time point

In step S1106, the UE may compare the first RSRP and the second RSRP.

In step S1108, the UE may estimate for a mobility state of the UE based on a difference between the first RSRP and the second RSRP.

Further, the UE may determine the mobility state of the UE based on multiple results of estimation for the mobility state. The mobility state of the UE may be determined as a certain mobility state, if the mobility state of the UE is estimated as the certain mobility state for a preconfigured number of times in a row. The mobility state of the UE may be determined as a highest mobility state among the multiple results of the estimation of the mobility state. Further, the UE may prepare for cell reselection procedure, when the mobility state of the UE is determined as high mobility state.

When the mobility state is estimated according to an embodiment of the present invention, the UE may vary the parameters related to the cell reselection. When the UE enters high mobility state, the UE should prepare for the quick cell change. If following the rules in legacy LTE network, the UE may scale the cell reselection-related parameters (i.e. Q_{hyst} and T_{reselectionXRAT}) or relax the measurement rules for cell reselection so that the UE starts to perform the neighbor cell measurement earlier. When the UE enters low mobility state (being stationary), it may mean the measured serving cell power varies very slowly. So it may be considered that the UE is in stationary state. If then, the UE may not perform neighbor cell measurement to reduce power consumption.

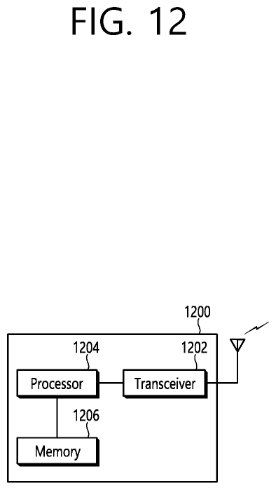

FIG. 12 shows a structure of UE according to an embodiment of the present invention.

According to an embodiment of the present invention, the UE 1200 may comprise transceiver 1202, processor 1204 and memory 1206. The memory 1206 is coupled to the processor 1204, and stores a variety of information for driving the processor 1204. The transceiver 1202 is coupled to the processor 1204, and transmits and/or receives a radio signal. The processor 1204 implements the proposed functions, procedures, and/or methods. In the aforementioned embodiments, an operation of the UE 1200 may be implemented by the processor 1204.

The processor 1204 may include application-specific integrated circuit (ASIC), other chipset, logic circuit and/or data processing device. The memory 1206 may include read-only memory (ROM), random access memory (RAM), flash memory, memory card, storage medium and/or other storage device. The transceiver 1202 may include baseband circuitry to process radio frequency signals. When the embodiments are implemented in software, the techniques described herein can be implemented with modules (e.g., procedures, functions, and so on) that perform the functions described herein. The modules can be stored in memories and executed by processor 1204. The memory 1206 can be implemented within the processor 1204 or external to the processor 1204 in which case those can be communicatively coupled to the processor 1204 via various means as is known in the art.

The processor 1204 may be configured to measure a first reference signal received power (RSRP) of a serving cell at a first time point. Further, the processor 1204 may be configured to measure a second RSRP of the serving cell at a second time point within a first duration starting from the first time point. Further, the processor 1204 may be configured to compare the first RSRP and the second RSRP. Further, the processor 1204 may be configured to estimate for a mobility state of the UE based on a difference between the first RSRP and the second RSRP.

The mobility state may be estimated based on the difference between the first RSRP and the second RSRP, and at least one of level thresholds related to the mobility state. The second RSRP of the serving cell may be measured at the second time point after a second duration starting from the first time point.

Further, the processor 1204 may be configured to determine the mobility state of the UE based on multiple results of estimation for the mobility state. The mobility state of the UE may be determined as a certain mobility state, if the mobility state of the UE is estimated as the certain mobility state for a preconfigured number of times in a row. The mobility state of the UE may be determined as a highest mobility state among the multiple results of the estimation of the mobility state. Further, the processor 1204 may be configured to prepare for cell reselection procedure, when the mobility state of the UE is determined as high mobility state.

When the mobility state is estimated according to an embodiment of the present invention, the UE may vary the parameters related to the cell reselection. When the UE enters high mobility state, the UE should prepare for the quick cell change. If following the rules in legacy LTE network, the UE may scale the cell reselection-related parameters (i.e. Q_{hyst} and T_{reselectionXRAT}) or relax the measurement rules for cell reselection so that the UE starts to perform the neighbor cell measurement earlier. When the UE enters low mobility state (being stationary), it may mean the measured serving cell power varies very slowly. So it may be considered that the UE is in stationary state. If then, the UE may not perform neighbor cell measurement to reduce power consumption.

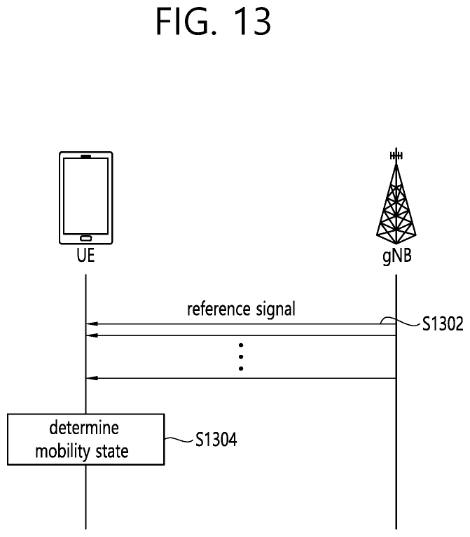

FIG. 13 shows an example of a method for determining mobility state of a UE according to an embodiment of the present invention. In this embodiment, a base station (BS) may be at least one of eNB or gNB, and also may be referred as a serving cell.

In step S1302, the serving cell may transmit reference signal to UE. The serving cell may transmit the reference signal for N times.

In step S1304, the UE may measure quality of the serving cell based on each reference signal. The UE may determine the mobility state based on variation of the serving cell qualities.

When the mobility state is estimated according to an embodiment of the present invention, the UE may vary the parameters related to the cell reselection. When the UE enters high mobility state, the UE should prepare for the quick cell change. If following the rules in legacy LTE network, the UE may scale the cell reselection-related parameters (i.e. Q_{hyst} and T_{reselectionXRAT}) or relax the measurement rules for cell reselection so that the UE starts to perform the neighbor cell measurement earlier. When the UE enters low mobility state (being stationary), it may mean the measured serving cell power varies very slowly. So it may be considered that the UE is in stationary state. If then, the UE may not perform neighbor cell measurement to reduce power consumption.

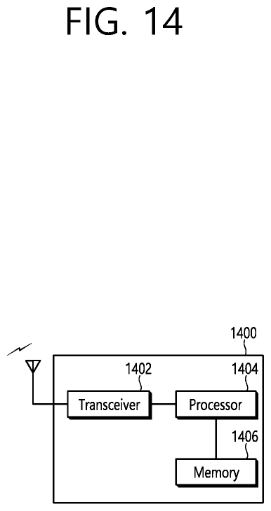

FIG. 14 shows a structure of network according to an embodiment of the present invention. In this embodiment, a base station (BS) 1400 may be at least one of eNB or gNB, and also may be referred as a serving cell.

According to an embodiment of the present invention, the BS 1400 may comprise transceiver 1402, processor 1404 and memory 1406. The memory 1406 is coupled to the processor 1404, and stores a variety of information for driving the processor 1404. The transceiver 1402 is coupled to the processor 1404, and transmits and/or receives a radio signal. The processor 1404 implements the proposed functions, procedures, and/or methods. In the aforementioned embodiments, an operation of the BS 1400 may be implemented by the processor 1404.

The processor 1404 may include application-specific integrated circuit (ASIC), other chipset, logic circuit and/or data processing device. The memory 1406 may include read-only memory (ROM), random access memory (RAM), flash memory, memory card, storage medium and/or other storage device. The transceiver 1402 may include baseband circuitry to process radio frequency signals. When the embodiments are implemented in software, the techniques described herein can be implemented with modules (e.g., procedures, functions, and so on) that perform the functions described herein. The modules can be stored in memory 1406 and executed by processor 1404. The memory 1406 can be implemented within the processor 1404 or external to the processor 1404 in which case those can be communicatively coupled to the processor 1404 via various means as is known in the art.

The processor 1404 may be configured to provide reference signal to UE. The UE may measure quality of the serving cell. The UE may determine the mobility state based on variation of the serving cell qualities.

When the mobility state is estimated according to an embodiment of the present invention, the UE may vary the parameters related to the cell reselection. When the UE enters high mobility state, the UE should prepare for the quick cell change. If following the rules in legacy LTE network, the UE may scale the cell reselection-related parameters (i.e. Qhyst and TreselectionXRAT) or relax the measurement rules for cell reselection so that the UE starts to perform the neighbor cell measurement earlier. When the UE enters low mobility state (being stationary), it may mean the measured serving cell power varies very slowly. So it may be considered that the UE is in stationary state. If then, the UE may not perform neighbor cell measurement to reduce power consumption.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

1. A method for a user equipment (UE) in wireless communication system, the method comprising:
measuring a first reference signal received power (RSRP) of a serving cell at a first time point;
measuring a second RSRP of the serving cell at a second time point within a first duration starting from the first time point;
comparing the first RSRP and the second RSRP; and
estimating for a mobility state of the UE based on a difference between the first RSRP and the second RSRP.

2. The method of claim 1, wherein the mobility state is estimated based on the difference between the first RSRP and the second RSRP, and at least one of level thresholds related to the mobility state.

3. The method of claim 1, wherein the second RSRP of the serving cell is measured at the second time point after a second duration starting from the first time point.

4. The method of claim 1, further comprising:
determining the mobility state of the UE based on multiple results of estimation for the mobility state.

5. The method of claim 4, wherein the mobility state of the UE is determined as a certain mobility state, if the mobility state of the UE is estimated as the certain mobility state for a preconfigured number of times in a row.

6. The method of claim 4, wherein the mobility state of the UE is determined as a highest mobility state among the multiple results of the estimation of the mobility state.

7. The method of claim 1, further comprising:
preparing for cell reselection procedure, when the mobility state of the UE is determined as high mobility state.

8. A user equipment (UE) in a wireless communication system, the UE comprising:
a transceiver for transmitting or receiving a radio signal; and
a processor coupled to the transceiver,
the processor configured to:
measure a first reference signal received power (RSRP) of a serving cell at a first time point;
measure a second RSRP of the serving cell at a second time point within a first duration starting from the first time point;
compare the first RSRP and the second RSRP; and
estimate for a mobility state of the UE based on a difference between the first RSRP and the second RSRP.

9. The UE of claim 8, wherein the mobility state is estimated based on the difference between the first RSRP and the second RSRP, and at least one of level thresholds related to the mobility state.

10. The UE of claim 8, wherein the second RSRP of the serving cell is measured at the second time point after a second duration starting from the first time point.

11. The UE of claim 8, wherein the processor is further configured to:
determine the mobility state of the UE based on multiple results of estimation for the mobility state.

12. The UE of claim 11, wherein the mobility state of the UE is determined as a certain mobility state, if the mobility state of the UE is estimated as the certain mobility state for a preconfigured number of times in a row.

13. The UE of claim 11, wherein the mobility state of the UE is determined as a highest mobility state among the multiple results of the estimation of the mobility state.

14. The UE of claim 8, wherein the processor is further configured to:
prepare for cell reselection procedure, when the mobility state of the UE is determined as high mobility state.

15. The method of claim 1, wherein the UE is in communication with at least one of a mobile device, a network, and/or autonomous vehicles other than the UE.
